(19) United States
(12) Patent Application Publication
(10) Pub. No.: US 2026/0099006 A1
(43) Pub. Date: Apr. 9, 2026

(54) OPTICAL DEVICE FOR POLARIZATION DEPENDENT LOSS COMPENSATION

(71) Applicant: HUAWEI TECHNOLOGIES CO., LTD., Shenzhen (CN)

(72) Inventors: Aria MOAVEN, Quebec (CA); Lixian WANG, Quebec (CA); Zhiping JIANG, Kanata (CA)

(21) Appl. No.: 18/910,575

(22) Filed: Oct. 9, 2024

(51) Int. Cl. G02B 6/27; G02B 6/35

(52) U.S. Cl. CPC G02B 6/2793; G02B 6/3538; G02B 6/3592

(57) ABSTRACT

An optical device for polarization dependent loss compensation and a polarization controlling wavelength selective switch (PC-WSS). The device includes a polarization independent liquid crystal on silicon (PI-LCoS) structure, a first liquid crystal structure disposed on the PI-LCOS structure; and a second liquid crystal structure disposed on the first liquid crystal layer, the two liquid crystal structures having a common ground electrode. The PI-LCOS structure includes a metamaterial quarter-wave plate (QWP) disposed over a silicon substrate. The PC-WSS includes an optical assembly arranged to receive light from a fiber array unit; a polarization-insensitive grating structure optically aligned with the optical assembly; and the optical device for polarization dependent loss compensation optically aligned with the polarization-insensitive grating structure.

### CROSS-REFERENCE TO RELATED APPLICATIONS

This is the first application filed for the instantly disclosed technology.

### TECHNICAL FIELD

The present disclosure generally relates to optical communications and, in particular, to devices for compensating polarization dependent loss.

### BACKGROUND

Optical communication systems have revolutionized global information transmission, leveraging light waves confined within optical fibers for high bandwidth, low-attenuation data transfer. However, these systems are susceptible to various impairments, such as polarization dependent loss (PDL).

Microscopic variations in fiber core geometry or external stresses can introduce birefringence, thereby introducing wavelength-dependent polarization changes. Various optical components and devices in an optical transmission system, such as a Wavelength Selective Switch (WSS) and amplifiers, further impact polarization dependent loss through their polarization sensitive components.

The polarization dependent loss of each component is generally a function of the state of polarization and the wavelength of the propagating light. This vector nature of PDL thus introduces different amounts of loss for different input polarization states and for different wavelengths. As the state of polarization along a link may have unpredictable fluctuations over time, the PDL may also change over time.

To this end, there is an interest in developing devices or systems for reducing or minimizing polarization dependent loss.

### SUMMARY

The implementations of the present disclosure have been developed based on developers' appreciation of the limitations associated with the prior art. Developers of the present technology have devised devices for controlling polarization state of an optical signal. There is provided an optical device for reducing polarization dependent loss. As polarization dependent loss (PDL) is function not only of the particular material being propagated through but also of the instant polarization state of signal, the optical device is configured and arranged to produce a desired state of polarization of a given signal. The desired polarization state is selected to accumulate the least PDL or to compensate a portion of the previously accumulated PDL through a given link, for example. In order to treat a broadband or multiwavelength signal, a polarization controlling wavelength selective switch (PC-WSS) is also provided herein. The PC-WSS separates the signal into each signal wavelength using a novel polarization insensitive grating structure, transforms the polarization state of each wavelength separately in the polarization controlling device, and then recollects the signal through the grating structure such that the signal can continue through the corresponding link or optical communication line.

As the polarization dependent loss is a function of the state of polarization (SOP), modifying the output SOP of a component in a given link or optical communication line can lead to changing or even minimizing the overall link's PDL. By using the proposed PC-WSS described herein, the SOP can be modified to a desired polarization state to reduce or minimize the polarization dependent loss. It is noted that use of a wavelength selective switch-type structure results in a generally more rapid and/or higher spatial resolution control than previously known solutions, such as fiber tapping mechanical interference.

In accordance with one broad aspect of the present disclosure, there is provided an optical device for polarization dependent loss compensation. The device includes a polarization independent liquid crystal on silicon (PI-LCOS) structure; a first liquid crystal structure disposed on the PI-LCOS structure; and a second liquid crystal structure disposed on the first liquid crystal layer.

In some embodiments, the optical device further includes an isolating layer between the PI-LCOS structure and the first liquid crystal structure.

In some embodiments, the optical device further includes a common ground electrode disposed between the first liquid crystal structure and the second liquid crystal structure, the common ground electrode providing electrical ground to an electrode of the first liquid crystal structure and an electrode of the second electrode.

In some embodiments, the PI-LCOS structure further includes a silicon substrate; a metamaterial quarter-wave plate (QWP) disposed over the silicon substrate; and a base liquid crystal structure disposed over the silicon substrate, the first liquid crystal structure being stacked over the base liquid crystal structure.

In some embodiments, the optical device further includes a cladding layer between the metamaterial QWP structure and the base liquid crystal structure.

In some embodiments, the base liquid crystal structure includes a first base electrode disposed between the silicon substrate and the metamaterial QWP; a first base alignment layer disposed on the metamaterial QWP; a base liquid crystal layer disposed on the first base alignment layer; a second base alignment layer disposed on the base liquid crystal layer; and a second base electrode disposed on the second base alignment layer.

In some embodiments, the second base electrode is a base ground electrode providing electrical ground to the first base electrode.

In some embodiments, the first liquid crystal structure further includes a first electrode, a first bottom alignment layer disposed on the first electrode, a first liquid crystal layer disposed on the first bottom alignment layer, and a first top alignment layer disposed on the first liquid crystal layer. The second liquid crystal structure includes a second electrode, a second bottom alignment layer, a second liquid crystal layer disposed on the second bottom alignment layer, and a second top alignment layer disposed on the second liquid crystal layer. In some embodiments, the optical device further includes a common ground electrode is disposed between the first top alignment layer and the second bottom alignment layer, the common ground electrode providing electrical ground to the first electrode and the second electrode.

In accordance with another broad aspect of the present disclosure, there is provided a polarization controlling wavelength selective switch (PC-WSS). The PC-WSS includes an optical assembly arranged to receive light from a fiber array unit; a polarization-insensitive grating structure optically aligned with the optical assembly; and an optical device for polarization dependent loss compensation optically aligned with the polarization-insensitive grating structure. The device includes a polarization independent liquid crystal on silicon (PI-LCoS) structure, a first liquid crystal layer disposed on the PI-LCOS structure, and a second liquid crystal layer disposed on the first liquid crystal layer.

In some embodiments, the polarization-insensitive grating structure includes a transparent substrate; a polarization-insensitive mirror coating applied to a first surface of the transparent substrate; and a transmissive grating applied to a second surface of the transparent substrate, the second surface being spaced from the first surface.

In some embodiments, the optical assembly includes at least one collimating lens.

In some embodiments, the optical assembly includes a first cylindrical lens; and a second cylindrical lens optically aligned with the first cylindrical lens, a major axis of the first cylindrical lens being arranged orthogonally to a major axis of the second cylindrical lens.

In some embodiments, the optical device further includes an isolating layer between the PI-LCOS structure and the first liquid crystal structure.

In some embodiments, the optical device further includes a common ground electrode disposed between the first liquid crystal structure and the second liquid crystal structure, the common ground electrode providing electrical ground to an electrode of the first liquid crystal structure and an electrode of the second electrode.

In some embodiments, the PI-LCOS structure includes a silicon substrate; a metamaterial quarter-wave plate (QWP) disposed over the silicon substrate; and a base liquid crystal structure disposed over the silicon substrate, the first liquid crystal structure being stacked over the base liquid crystal structure.

In some embodiments, the optical device further includes a cladding layer between the metamaterial QWP structure and the base liquid crystal structure.

In some embodiments, the base liquid crystal structure includes a first base electrode disposed between the silicon substrate and the metamaterial QWP; a first base alignment layer disposed on the metamaterial QWP; a base liquid crystal layer disposed on the first base alignment layer; a second base alignment layer disposed on the base liquid crystal layer; and a second base electrode disposed on the second base alignment layer.

In some embodiments, the second base electrode is a base ground electrode providing electrical ground to the first base electrode.

In some embodiments, the first liquid crystal structure includes a first electrode, a first bottom alignment layer disposed on the first electrode, a first liquid crystal layer disposed on the first bottom alignment layer, and a first top alignment layer disposed on the first liquid crystal layer; the second liquid crystal structure includes a second electrode, a second bottom alignment layer, a second liquid crystal layer disposed on the second bottom alignment layer, and a second top alignment layer disposed on the second liquid crystal layer; and further including a common ground electrode is disposed between the first top alignment layer and the second bottom alignment layer, the common ground electrode providing electrical ground to the first electrode and the second electrode.

In the context of the present specification, unless provided expressly otherwise, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first processor” and “third processor” is not intended to imply any particular order, type, chronology, hierarchy or ranking (for example) of/between the processors, nor is their use (by itself) intended to imply that any “second processor” must necessarily exist in any given situation. Further, as is discussed herein in other contexts, reference to a “first” element and a “second” element does not preclude the two elements from being the same actual real-world element. Thus, for example, in some instances, a “first” processor and a “second” processor may be the same software and/or hardware, in other cases they may be different software and/or hardware.

In the context of the present specification, when an element is referred to as being “associated with” another element, in certain implementations, the two elements can be directly or indirectly linked, related, connected, coupled, the second element employs the first element, or the like without limiting the scope of the present disclosure.

The terminology used herein is only intended to describe particular representative implementations and is not intended to be limiting of the present technology. As used herein, the singular forms “a,” “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

It will be understood that when an element is referred to as being “connected” or “coupled” to another element, it can be directly or indirectly connected or coupled to the other element or intervening elements that may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

In the present disclosure, “at least one” means one or more, and “a plurality of” means two or more. The term “and/or” describes an association relationship of associated objects, and indicates that three relationships may exist. For example, A and/or B may indicate the following three cases: Only A exists, both A and B exist, and only B exists, where A and B may be singular or plural. The character “/” indicates an “or” relationship between associated objects. “At least one of the following items (pieces)” or a similar expression thereof indicates any combination of these items, including a single item (piece) or any combination of a plurality of items (pieces). For example, “at least one of A, B, or C” includes: only A; only B; only C; A and B; A and C; B and C; or A, B, and C, and “at least one of A, B, and C” may also be understood as including: only A; only B; only C; A and B; A and C; B and C; or A, B, and C.

Unless otherwise defined or indicated by context, all technical and scientific terms used herein have the same meaning as commonly understood by one of ordinary skill in the art to which the described implementations appertain to. The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor” or a “controller”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some implementations of the present technology, the processor may be a general-purpose processor, such as a central processing unit (CPU) or a processor dedicated to a specific purpose, such as a graphics processing unit (GPU). Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

As used herein, the term “about” or “approximately” refers to a +/−10% variation from the nominal value. It is to be understood that such a variation is always included in a given value provided herein, whether or not it is specifically referred to.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

### BRIEF DESCRIPTION OF THE FIGURES

Further features and advantages of the present disclosure will become apparent from the following detailed description, taken in combination with the appended drawings, in which:

FIG. 1 is a schematic, side elevation view of an optical device for polarization dependent loss compensation according to one non-limiting embodiment of the present technology;

FIG. 2 is a top, side perspective view of the optical device of FIG. 1;

FIG. 3 is a top plan view of a polarization controlling wavelength selective switch (PC-WSS) including the optical device of FIG. 1; and

FIG. 4 is a perspective view of the PC-WSS of FIG. 3.

It is to be understood that throughout the appended drawings and corresponding descriptions, like features are identified by like reference characters. Furthermore, it is also to be understood that the drawings and ensuing descriptions are intended for illustrative purposes only and that such disclosures do not provide a limitation on the scope of the claims. Drawings may not be drawn to scale.

### DETAILED DESCRIPTION

Furthermore, as an aid to understanding, the following description may describe relatively simplified implementations of the present technology. As persons skilled in the art would understand, various implementations of the present technology may be of a greater complexity.

The instant disclosure is directed to address at least some of the deficiencies of the current technology. In particular, the instant disclosure describes an optical device for polarization dependent loss compensation, as well as a polarization controlling wavelength selective switch (PC-WSS). The optical device and the PC-WSS provide control of the state of polarization of propagating light, with the PC-WSS providing polarization control of the signal on a per channel basis, or separate control on each wavelength or small wavelength band.

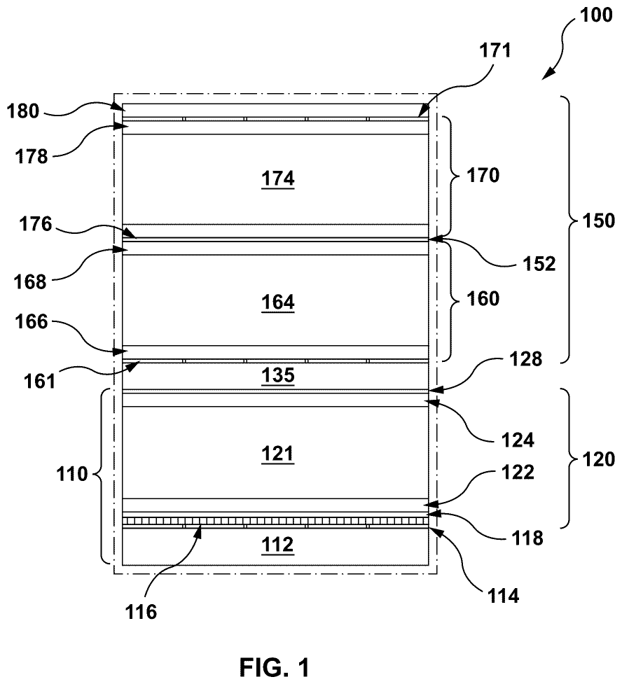

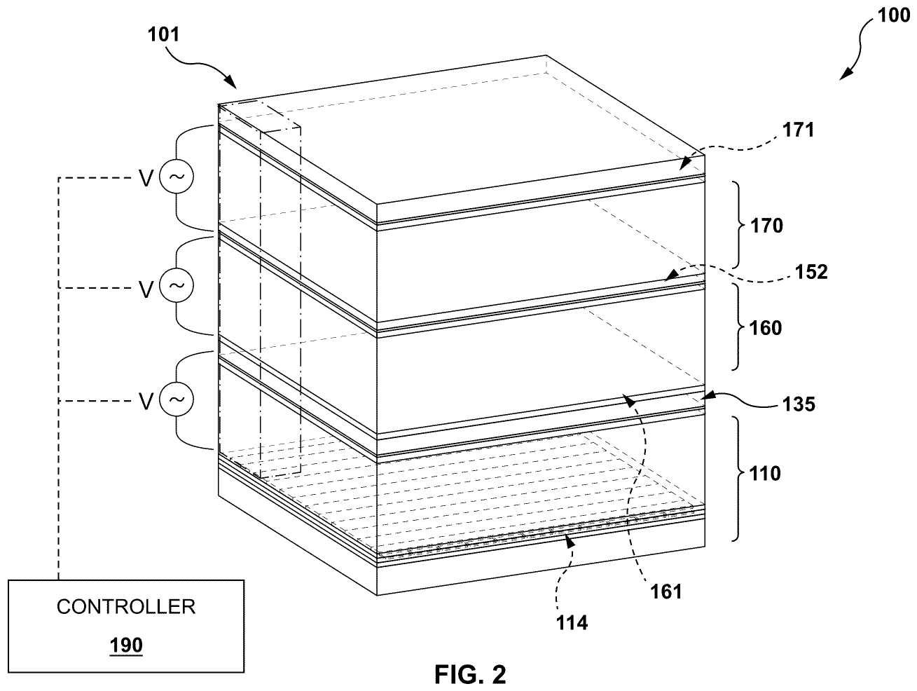

With reference to FIGS. 1 and 2, according to non-limiting embodiments of the present technology, there is presented an optical device 100 for polarization dependent loss compensation.

The optical device 100, also referred to herein as the device 100, includes a polarization independent liquid crystal on silicon (PI-LCOS) structure 110. The device 100 further includes a liquid crystal (LC) structure 150 disposed on the PI-LCOS structure 110. It is noted that the orientations used herein (top, bottom, on, under, etc.) are assigned for simplicity of description, but do not necessarily indicate the spatial orientation of the device 100 in use. The LC structure 150 is optically aligned and in contact with the PI-LCOS structure 110, such that light transmitted through the LC structure 150 is received by the PI-LCOS structure 110 and subsequently reflected or propagated back through the LC structure 150. Operation of the device 100 is described in more detail below.

The overall LC structure 150 is broadly composed of two stacked liquid crystal structures. A first liquid crystal structure 160, also referred to herein as an assembly 160, is disposed on the PI-LCOS structure 110. A second liquid crystal structure 170, also referred to herein as an assembly 170, disposed on the first liquid crystal assembly 160.

The first liquid crystal structure 160 includes an electrode 161, a bottom alignment layer 166 disposed on the electrode 161, a liquid crystal layer 164 disposed on the bottom alignment layer 166, and a top alignment layer 168 disposed on the liquid crystal layer 164. The second liquid crystal structure similarly includes a bottom alignment layer 176, a liquid crystal layer 174 disposed on the bottom alignment layer 176, a top alignment layer 178 disposed on the liquid crystal layer 174, and an electrode 171 disposed on the top alignment layer 178.

The LC structure 150 further includes a common ground electrode 152 disposed between the alignment layers 168, 176 of the first and second liquid crystal structures 160, 170. The ground electrode 152 provides one common electrical ground to the electrodes 161, 171 of both liquid crystal structures 160, 170. The ground electrode 152 is a single plane of electrode material connected to an electrical ground; the ground electrical connection is provided by a controller 190. It is at least some embodiments, it is contemplated that the controller 190 could take the form of a voltage controller operatively connected to the first and second liquid crystal structures 160, 170. By arranging the first and second liquid crystal structures 160, 170 such that a single ground electrode can be used for both liquid crystal layers 164, 174, an overall thickness of device 100, compared to the implementation to two full liquid crystal devices with separate ground contacts.

Each electrode 152, 161, 171 is formed from transparent electrically-active strips (not shown) which control the retardance induced in the corresponding liquid crystal structure 160, 170. The width of each strip is determined by the number of subchannels of the signal to be treated, or cells to be formed, with a gap between each two adjacent stripes being as small as possible. The electrode layers may be fabricated using standard lithography and deposition methods in at least some embodiments. The particular form and construction of the electrodes 152, 161, 171 could vary in different embodiments.

As per standard liquid crystal devices, the alignment layers 166, 168, 176, 178 create a permanent electrical field to tilt the direction of the dipoles inside the corresponding liquid crystal layer 164, 174 in a pre-defined direction. The retardance induced is then controlled by a combination of the configuration of the alignment layers 166, 168, 176, 178 and the electrodes 152, 161, 171. Each cell of the electrodes 152, 161, 171 can be controlled separately, thereby forming cells that can each have a separately controllable retardance. An example cell 101 of the device 100 is shown schematically in FIG. 2, where cells of each liquid crystal structure 160, 170 and cells of the PI-LCOS 110 form corresponding cells 101 along an optical axis direction of the device 100.

Between the LC structure 150 and the PI-LCOS structure 110, the device 100 further includes an isolating layer 135. The isolating layer 135 is an optically transparent, electrically isolating barrier to permit transmission of light therethrough while preventing electrical cross-talk between the electrodes of the LC structure 150 and those of the PI-LCOS structure 110. The isolating layer 135 could be formed from a variety of materials, including but not limited to: Silica (SiO₂). The device 100 further includes a protective layer 180 disposed on top of the LC structure 150. The protective layer 180 could be formed from a variety of materials, including but not limited to: Silica (SiO₂).

With continued reference to FIGS. 1 and 2, The PI-LCOS structure 110 has a silicon substrate 112, in the form of a flat plate in the illustrated embodiment. Disposed on the substrate 112 is a base liquid crystal structure 120, also referred to as the base liquid crystal assembly 120, on which the LC structure 150 is stacked.

The PI-LCOS structure 110 includes a metamaterial quarter-wave plate (QWP) 116 disposed over the silicon substrate 112. In the present embodiment, the PI-LCOS structure 110 further includes a cladding layer 118 between the liquid crystal base assembly 120 and the metamaterial QWP 116. The material of the cladding layer 118 is chosen based on the metamaterial QWP 116, as the full effect of the QWP 116 depends on the refractive index of the cladding layer 118. The cladding 118 further acts as a substrate layer for the alignment layer 122.

The base liquid crystal structure 120 includes a first electrode 114 and a second electrode 128, as well as a liquid crystal layer 121 disposed therebetween. The first electrode 114 disposed between the silicon substrate 112 and the metamaterial QWP 116.

The base liquid crystal structure 120 also includes two alignment layers formed around the liquid crystal layer 121. A first base alignment layer 122 is situated between the metamaterial QWP 116 and the liquid crystal layer 121. A second base alignment layer 124 is disposed between the liquid crystal layer 121 and the second electrode 128. The alignment layers 122, 124 and their corresponding electrodes 114, 128 serve to control the alignment and polarization effects of the liquid crystal layer 121. In the illustrated embodiment, the second electrode 128, disposed between the LC structure 150 and the alignment layer 124, is a ground electrode 128 providing electrical ground to the first electrode 114.

As is illustrated schematically in FIG. 2, the electrodes 114, 128, 161, 171 are operatively connected to the controller 190, which could be a voltage controller 190 in at least some embodiments. The controller 190 controls the retardance of the liquid crystal structure 120 of the PI-LCOS structure 110 such that, in combination with the metamaterial QWP 116, the state of polarization of the light is maintained. The controller 190 further controls the retardance of the LC structure 150, and more specifically each cell thereof, such that a desired retardance can be applied to the light treated by the device 100.

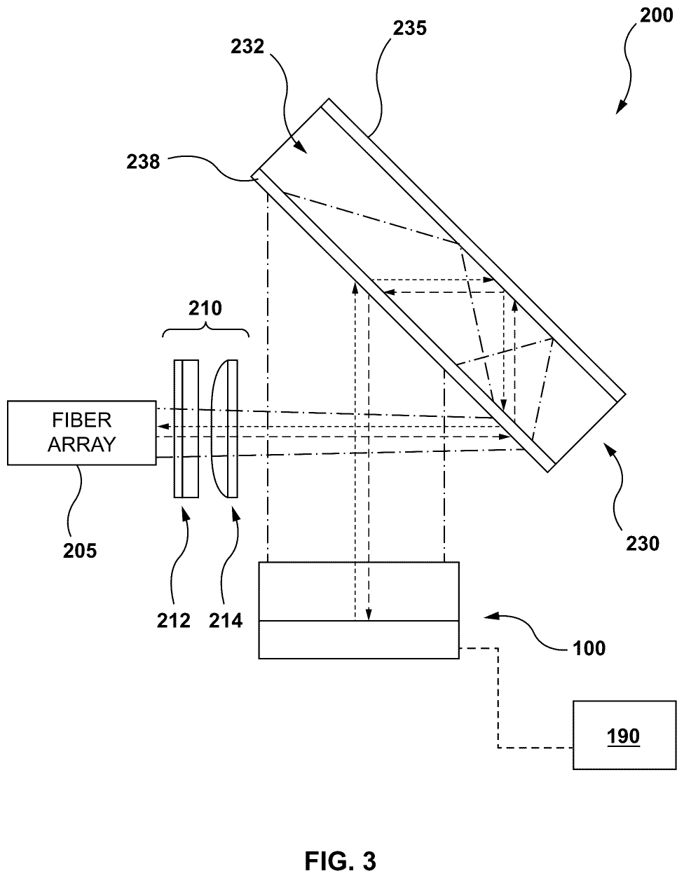

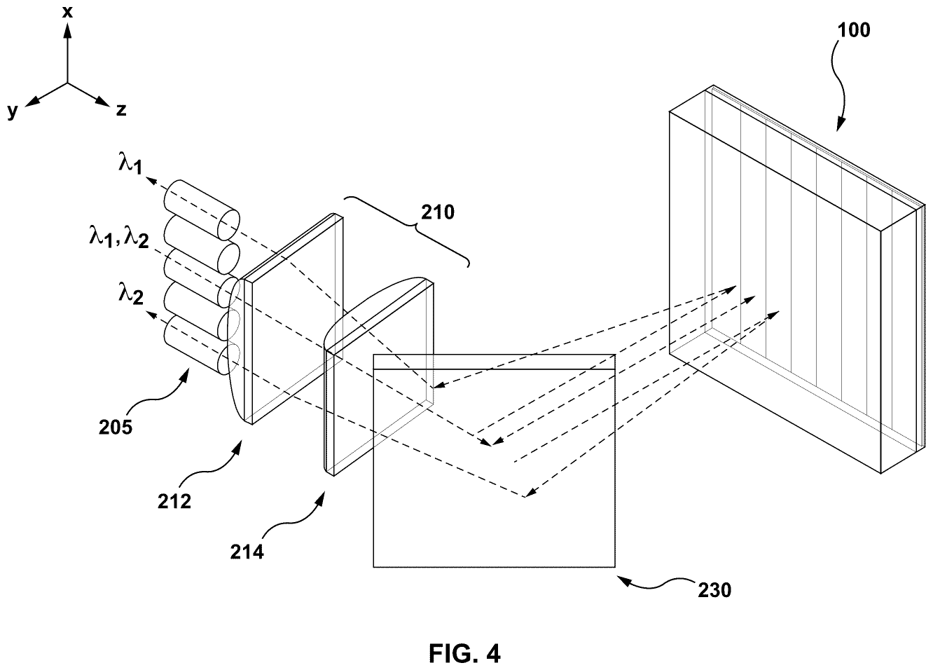

With reference to FIGS. 3 and 4, the optical device 100 is illustrated as implemented in a polarization controlling wavelength selective switch (PC-WSS) 200, also referred to herein as the switch 200. An example implementation of the PC-WSS 200 in an optical communication system 50 is illustrated schematically in FIG. 4. Although described as a stand-alone wavelength selective switch, it is also contemplated that the assembly of the PC-WSS 200 could be incorporated into a larger WSS structure in some cases.

The switch 200 is arranged and configured to receive light from and return light to an optical fiber array 205. The switch 200 includes an optical assembly 210 for at least partially collimating light from the fiber array 205. As is illustrated in FIG. 4, the optical assembly 210 also focuses light exiting the switch 200 into the fiber array 205. The particular input and output arrangement could vary in different embodiments, including the number and arrangement of fibers in the fiber array 205. The optical assembly 210 generally includes one collimating lens and/or a collimating and focusing element. In the illustrated embodiment, the optical assembly 210 includes two cylindrical lenses, specifically a first cylindrical lens 212 and a second cylindrical lens 214. The second cylindrical lens 214 is optically aligned with the first cylindrical lens 212, with a major axis of the first cylindrical lens 212 being arranged orthogonally to a major axis of the second cylindrical lens 214. A variety of other optical assemblies are contemplated for use as the collimating/focusing optical assembly 210.

The switch 200 includes a polarization-insensitive grating structure 230 optically aligned with the optical assembly 210. After collimation, or partial collimation, by the optical assembly 210, the grating structure 230 separates the light from the fiber array 205 into its wavelength components for wavelength-by-wavelength polarization treatment by the optical device 100.

By the present embodiment, the polarization-insensitive grating structure 230 is formed around a transparent substrate 232. The substrate 232 is generally glass, but the material could be chosen from among a variety of non-birefringent materials. The polarization-insensitive grating structure 230 includes a polarization-insensitive mirror coating 235 applied to one surface of the transparent substrate 232. In some embodiments, the mirror coating 235 could be formed by a deposited this film gold layer. It is also contemplated that different materials could be used to form the mirror coating, although a polarization insensitive or maintaining material must be chosen.

The polarization-insensitive grating structure 230 further includes a transmissive grating 238 applied to a surface of the transparent substrate 232, opposite the mirror coating 235. The surface of the grating 238 is spaced from the surface with the mirror coating 235 by the thickness of the transparent substrate 232. The specific thickness of the substrate 232, and thus the spacing between the grating 238 and the mirror coating 235, will vary depending on particulars of the implementation, for instance on the bandwidth of the signal to be treated and the diffractive spread of the grating 238. Applying the mirror coating 235 and the grating 238 to the transparent substrate 232, rather than having two free space components, aids in decreasing alignment and spacing issues within the PC-WSS 200 during fabrication and operation.

The switch 200 further includes the optical device 100 optically aligned with the grating structure 230. With reference to FIG. 3, light propagation through the PC-WSS 200 will now be described. An input beam from the fiber array 205 is emitted into the two cylindrical lenses 212, 214 to collimate the light. The light is subsequently incident the polarization-insensitive transmissive grating 238 which diffracts the light into a diverging beam.

This diverging beam is then reflected by the polarization-insensitive mirror 235. The reflected beam continues back through the grating 238 and is diffracted for the second time. The grating 238 and the mirror 235 are arranged parallel such that the light is collimated after the second pass through the grating 238. The spacing between the grating 238 and the mirror 238 is arranged to produce a beam size appropriate for the device 100 (i.e. such that the beam is not larger than the device 100 acceptance area, but otherwise generally filing the acceptance area of the device 100). Further, following the two passes through the grating 238, the light has been diffracted into its wavelength components, such that one wavelength or one small bandwidth of the light is incident on each of the different cells formed in the device 100.

The collimated, diffracted light propagates to the device 100. The light is incident on the device 100 at a normal angle (perpendicular to the surfaces of the device 100), such that each wavelength of the light passes through a known distance and path in the device 100. The light then propagates through the LC structure 150, into and is reflected back out of the PI-LCOS 110, and back through the LC structure 150 a second time. The controller 190 controls the retardance of each cell, such as the cell 101, of the device 100 to transform its state of polarization of light passing through each corresponding cell 101. The beam having been treated by the device 100 then again passes through the grating 238, is reflected by the polarization-insensitive mirror 235, and back through the grating 238 to be recollimated and returned to the fiber array 205 through the cylindrical lenses 212, 214.

As is noted above, the retardance of each cell of the device 100 is separately controllable. The overall device 100 thus has a predictable, calculable effect on the state of polarization of the light treated thereby. Using standard Stokes/Mueller calculation, the retardance of each of the liquid crystal structures 160, 170 required to form an arbitrary output state of polarization from an arbitrary input state of polarization can be determined.

In order to transform from an input state of polarization Sⁱ to an output state of polarization S^{O}, the required retardance of the first liquid crystal structure 160 is:

$${B}_{1} ( {S}^{i} , {S}^{o} ) = {tan}^{- 1} ( \frac{{S}_{2}^{i} + {S}_{2}^{o}}{{S}_{3}^{o} - {S}_{3}^{i}} ) , 0 < {B}_{1} < π , \qquad ( Eq . 1 )$$

and the required retardance of the second liquid crystal structure 170 is:

$${B}_{2} ( {S}^{i} , {S}^{o} ) = {tan}^{- 1} ( - \frac{sin {B}_{1} ( {S}_{2}^{o} + {S}_{2}^{i} ) + cos {B}_{1} ( {S}_{3}^{o} - {S}_{3}^{i} )}{{S}_{1}^{o} - {S}_{1}^{i}} ) , 0 < {B}_{2} < π , \qquad ( Eq . 2 )$$

$$where {S}^{o} = [ \begin{matrix}{S}_{0}^{o} \\ {S}_{1}^{o} \\ {S}_{2}^{o} \\ {S}_{3}^{o}\end{matrix} ] and {S}^{i} = [ \begin{matrix}{S}_{o}^{i} \\ {S}_{1}^{i} \\ {S}_{2}^{i} \\ {S}_{3}^{i}\end{matrix} ] \qquad ( Eqs . 3 , 4 )$$

are the output and input states of polarization respectively, in Stokes representation. As can be seen from the resultant calculation for the required retardance B₁ and B₂ of the liquid crystal structures 160, 170, the maximum retardance necessary at either structure is π radians. By not requiring either liquid crystal structure 160, 170 to be able to produce more than π retardance, the overall device 100 has an overall reduced thickness compared to the replacement of one or both liquid crystal structures 160, 170 with liquid crystal assemblies able to reach 2π retardance. The required thickness of each liquid crystal layer 164, 175 is about 50% less than the thickness required for a liquid crystal assembly with a retardance ranging from 0 to 2π.

By using the PC-WSS 200 in an optical communication line, the polarization dependent loss can thus be reduced or minimized for each channel (i.e. wavelength). Specifically, knowing the polarization state of each channel before the PC-WSS 200, the PC-WSS 200 can control the output polarization state of each channel to be the polarization state which accumulates the minimum PDL.

It will also be understood that, although the embodiments presented herein have been described with reference to specific features and structures, it is clear that various modifications and combinations may be made without departing from such disclosures. The specification and drawings are, accordingly, to be regarded simply as an illustration of the discussed embodiments or implementations and their principles as defined by the appended claims, and are contemplated to cover any and all modifications, variations, combinations or equivalents that fall within the scope of the present disclosure.

What is claimed is:

1. An optical device for polarization dependent loss compensation, the device comprising:
a polarization independent liquid crystal on silicon (PI-LCoS) structure;
a first liquid crystal structure disposed on the PI-LCOS structure; and
a second liquid crystal structure disposed on the first liquid crystal layer.

2. The optical device of claim 1, further comprising an isolating layer between the PI-LCOS structure and the first liquid crystal structure.

3. The optical device of claim 1, further comprising a common ground electrode disposed between the first liquid crystal structure and the second liquid crystal structure, the common ground electrode providing electrical ground to an electrode of the first liquid crystal structure and an electrode of the second electrode.

4. The optical device of claim 1, wherein the PI-LCOS structure comprises:
a silicon substrate;
a metamaterial quarter-wave plate (QWP) disposed over the silicon substrate; and
a base liquid crystal structure disposed over the silicon substrate, the first liquid crystal structure being stacked over the base liquid crystal structure.

5. The optical device of claim 4, further comprising a cladding layer between the metamaterial QWP structure and the base liquid crystal structure.

6. The optical device of claim 4, wherein the base liquid crystal structure comprises:
a first base electrode disposed between the silicon substrate and the metamaterial QWP;
a first base alignment layer disposed on the metamaterial QWP;
a base liquid crystal layer disposed on the first base alignment layer;
a second base alignment layer disposed on the base liquid crystal layer; and
a second base electrode disposed on the second base alignment layer.

7. The optical device of claim 6, wherein the second base electrode is a base ground electrode providing electrical ground to the first base electrode.

8. The optical device of claim 1, wherein:
the first liquid crystal structure comprises:
a first electrode,
a first bottom alignment layer disposed on the first electrode,
a first liquid crystal layer disposed on the first bottom alignment layer, and
a first top alignment layer disposed on the first liquid crystal layer;
the second liquid crystal structure comprises:
a second electrode,
a second bottom alignment layer,
a second liquid crystal layer disposed on the second bottom alignment layer, and
a second top alignment layer disposed on the second liquid crystal layer; and
further comprising a common ground electrode is disposed between the first top alignment layer and the second bottom alignment layer, the common ground electrode providing electrical ground to the first electrode and the second electrode.

9. A polarization controlling wavelength selective switch (PC-WSS) comprising:
an optical assembly arranged to receive light from a fiber array unit;
a polarization-insensitive grating structure optically aligned with the optical assembly; and
an optical device for polarization dependent loss compensation optically aligned with the polarization-insensitive grating structure, the device comprising:
a polarization independent liquid crystal on silicon (PI-LCoS) structure,
a first liquid crystal layer disposed on the PI-LCOS structure, and
a second liquid crystal layer disposed on the first liquid crystal layer.

10. The PC-WSS of claim 9, wherein the polarization-insensitive grating structure comprises:
a transparent substrate;
a polarization-insensitive mirror coating applied to a first surface of the transparent substrate; and
a transmissive grating applied to a second surface of the transparent substrate, the second surface being spaced from the first surface.

11. The PC-WSS of claim 9, wherein the optical assembly comprises at least one collimating lens.

12. The PC-WSS of claim 9, wherein the optical assembly comprises:
a first cylindrical lens; and
a second cylindrical lens optically aligned with the first cylindrical lens, a major axis of the first cylindrical lens being arranged orthogonally to a major axis of the second cylindrical lens.

13. The PC-WSS of claim 9, wherein the optical device further comprises an isolating layer between the PI-LCOS structure and the first liquid crystal structure.

14. The PC-WSS of claim 9, wherein the optical device further comprises a common ground electrode disposed between the first liquid crystal structure and the second liquid crystal structure, the common ground electrode providing electrical ground to an electrode of the first liquid crystal structure and an electrode of the second electrode.

15. The PC-WSS of claim 9, wherein the PI-LCOS structure comprises:
a silicon substrate;
a metamaterial quarter-wave plate (QWP) disposed over the silicon substrate; and
a base liquid crystal structure disposed over the silicon substrate, the first liquid crystal structure being stacked over the base liquid crystal structure.

16. The PC-WSS of claim 15, wherein the optical device further comprises a cladding layer between the metamaterial QWP structure and the base liquid crystal structure.

17. The PC-WSS of claim 15, wherein the base liquid crystal structure comprises:
a first base electrode disposed between the silicon substrate and the metamaterial QWP;
a first base alignment layer disposed on the metamaterial QWP;
a base liquid crystal layer disposed on the first base alignment layer;
a second base alignment layer disposed on the base liquid crystal layer; and
a second base electrode disposed on the second base alignment layer.

18. The PC-WSS of claim 17, wherein the second base electrode is a base ground electrode providing electrical ground to the first base electrode.

19. The PC-WSS of claim 9, wherein:
the first liquid crystal structure comprises:
a first electrode,
a first bottom alignment layer disposed on the first electrode,
a first liquid crystal layer disposed on the first bottom alignment layer, and
a first top alignment layer disposed on the first liquid crystal layer;
the second liquid crystal structure comprises:
a second electrode,
a second bottom alignment layer,
a second liquid crystal layer disposed on the second bottom alignment layer, and
a second top alignment layer disposed on the second liquid crystal layer; and
further comprising a common ground electrode is disposed between the first top alignment layer and the second bottom alignment layer, the common ground electrode providing electrical ground to the first electrode and the second electrode.
